(19) United States
(12) Patent Application Publication
(10) Pub. No.: US 2009/0194608 A1
(43) Pub. Date: Aug. 6, 2009

(54) SWIRL INDUCING NOZZLE SYSTEM

(76) Inventor: Arnold Bruckner, Brooklyn, NY (US)

Correspondence Address: LAW OFFICE OF MARC D. MACHTINGER, LTD., 750 W. LAKE COOK ROAD, SUITE 350, BUFFALO GROVE, IL, 60089, US

(21) Appl. No.: 12/026,313

(22) Filed: Feb. 5, 2008

(51) Int. Cl. B05B 1/28

(52) U.S. Cl. 239/290

(57) ABSTRACT

A swirl inducing spray nozzle system is disclosed. The spray nozzle system has a spray nozzle through which the substance to be sprayed passes. The spray nozzle system also has a nozzle cone. The nozzle cone has a substantially conical interior surface. Disposed on the interior surface of the nozzle cone is a plurality of gas injector ports. These gas injector ports are arranged and operated such the gas from the gas injector ports causes the substance being sprayed to rotate inside the nozzle cone, thus inducing a swirl into the substance being sprayed. The gas supply used for the gas injector ports can be pressure and or temperature controlled.

### FIELD OF THE INVENTION

The present invention relates to spray nozzles. More specifically, the present invention relates to a swirl inducing nozzle system, i.e., a spray nozzle system that induces a swirl, or tornado type effect, into the substance being sprayed.

### BACKGROUND OF THE INVENTION

Spray nozzles of various types are used throughout a variety of industries and endeavors. The most basic of nozzles work on the principle that a pressurized fluid, when passing through a restriction, will accelerate. This simple nozzle is understood by any child who has put a finger over the end of a garden hose.

A nearly infinite variety of nozzles working on this principle are available for commercial use. These nozzles operate with liquids of different viscosities, operate under different ranges of pressure, and operate at different volumetric flow rates. These nozzles often also are designed to produce various spray patterns, for example, some nozzles produce a flat fan, some nozzle produce a concentrated jet, while others produce a conical spray pattern.

Other nozzles work on a siphon principle. In these nozzles a first fluid, typically a gas, but sometimes a liquid, traveling through the spray nozzle system siphons (due to the lower pressure of the moving fluid) a second fluid from a reservoir into the first fluid, and ultimately into the spray pattern of the nozzle system. An example of a nozzle system working on the siphon principle in seen in an artist's air brush.

No matter what type of nozzle system used, lubricants and or medicated ointments are know to be beneficial when applied to various medical pads or similar devices. For example, in U.S. Pat. No. 4,572,174, which issued Feb. 25, 1986, we disclosed a bed pad structure intended to relieve the pressure, friction, and shear forces which are now recognized as principal causes of bedsores, pressure sores and decubitus ulcers in bedridden and chair ridden patients. We disclosed a low friction bed pad structure having a pouch portion between a woven fabric upper porous sheet and a lower flexible nonporous sheet. The pouch portion permitted insertion and removal of a lubricated sheet which exuded lubricant that seeped through the pores in the upper sheet to a patient's body when it applied pressure to the pad being held stationary on a bed, to reduce friction between the patient's body and the bed or other supporting surface to which the pad was attached.

Some of the shortcomings of the pads disclosed in U.S. Pat. No. 4,572,174 were addressed in U.S. Pat. No. 4,959,059, which issued Sep. 23, 1990. In U.S. Pat. No. 4,959,059, we disclosed a multilayer low friction ambulatory pad for treating or preventing bedsores and pressure sores and for managing fluids discharged from a person's body. The pad has a first slippery nonporous layer on which is a moisture absorbent second layer. A slippery, thin, porous third layer is on the second layer. The three layers are peripherally bonded to form a continuous seam which permits unbonded areas of the layers to slide slightly with respect to each other. The third layer may be sprayed with a filmy, dry, slippery fourth layer. A fifth layer of lubricating material, which may be a microencapsulated lubricant or a free lubricant, is applied to the third and fourth layers to form a very slippery top surface. The fourth and fifth layers do not clog the pores of the third layer, thus allowing passage of air and fluids to the absorbent second layer. In some variants of the pad, the absorbent layer is omitted. The pad can be discarded after a single use.

Microencapsulation is a process in which tiny particles or droplets are surrounded by a coating to give small capsules with many useful properties. In a relatively simplistic form, a microcapsule is a small sphere with a uniform wall around it. The material inside the microcapsule is referred to as the core, internal phase, or fill, whereas the wall is sometimes called a shell, coating, or membrane. Most microcapsules have diameters between a few micrometers and a few millimeters.

When a lubricant, emollient, or ointment is microencapsulated in a membrane, and applied to a product, the lubricant, and thus the product, can have an extended shelf life as the lubricant is preserved inside the membrane. The lubricant is not released until the membrane is ruptured, such as when the patient's weight is applied to a pad of the type discussed above.

There remains a need for an improved spray nozzle system. Specifically, there remains a need for an improved spray nozzle system that induces a swirl into the substance being sprayed. Furthermore, there remains a need to a spray nozzle system suitable for microencapsulating applications.

### SUMMARY

In view of the nozzles described above, it is an object of the present invention to provide an improved spray nozzle system.

It is a further object of the present invention to provide an improved spray nozzle system that induces a swirl into the substance being sprayed.

It is further object of the present invention to provide a spray nozzle system suitable for microencapsulating application.

The present invention is a swirl, or tornado effect, inducing spray nozzle system. The spray nozzle system has spray nozzle through which the substance to be sprayed passes. The spray nozzle system also has a nozzle cone.

The nozzle cone can be attached to the spray nozzle through the use of set screws or other means known in the art. An adaptor collar can be used to fit the nozzle cone to the spray nozzle. The nozzle cone has a top opening for receiving or operatively connecting to the spray nozzle. The nozzle cone also has a bottom opening that serves as the exit for the substance being sprayed. The nozzle cone has a substantially conical interior surface.

Disposed on the interior surface of the nozzle cone is a plurality of gas injector ports. These gas injector ports are arranged and operated such the gas from the gas injector ports causes the substance being sprayed to rotate inside the nozzle cone. In other words, the gas from the gas injector ports imparts a rotational force onto the substance being sprayed. In various preferred embodiments, the gas injector ports direct the gas tangentially to interior surface. In other various embodiments, the gas injector ports inject the gas perpendicularly to interior surface.

Preferably, the gas supply used for the gas injector ports is pressure controlled. In various preferred embodiments, the gas supply pressure for each gas injector port can be individually controlled. Additionally, the gas supply for the gas injector ports can be temperature controlled as well. In various preferred embodiments, the gas supply temperature for each gas injector port can be individually controlled. In other various preferred embodiments, the substance being sprayed is also temperature controlled.

Other features and advantages of the invention will be apparent from the following detailed description taken in conjunction with the following figures, wherein like reference numerals represent like features.

### BRIEF DESCRIPTION OF THE DRAWINGS

FIG. 1 is a perspective cut-away view of a spray nozzle according to the present invention.

FIG. 2 is a bottom view of a spray nozzle system according to the present invention.

### DETAILED DESCRIPTION OF THE INVENTION

While this invention is susceptible of embodiments in many different forms, there are shown in the drawings and will herein be described in detail, preferred embodiments of the invention with the understanding that the present disclosure is to be considered as an exemplification of the principles of the invention and is not intended to limit the broad aspect of the invention to the embodiments illustrated.

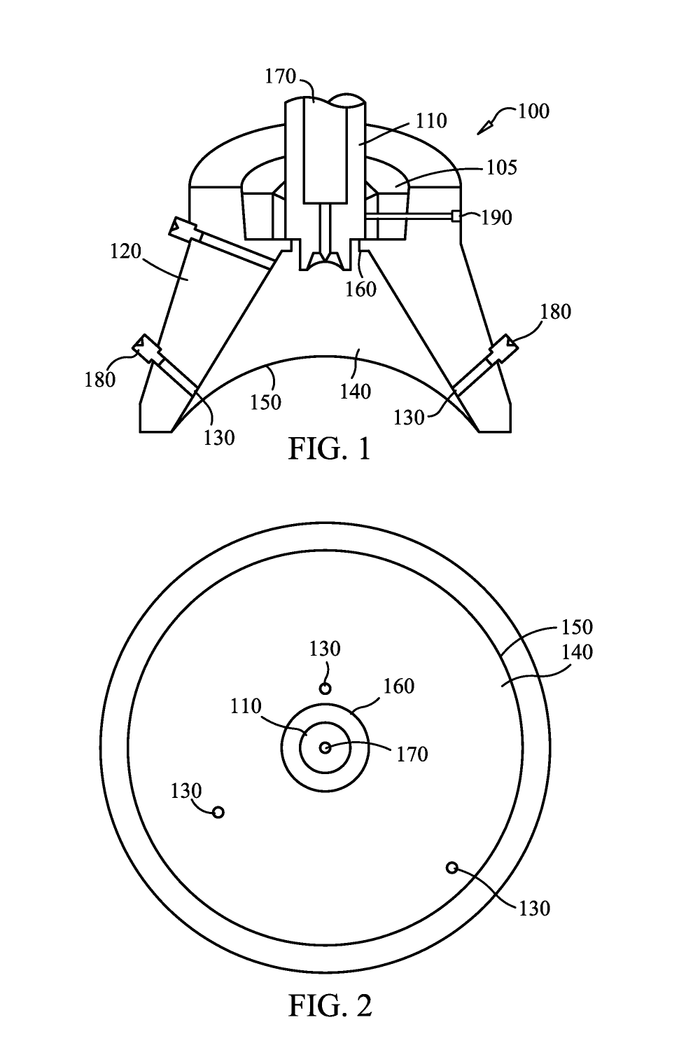

The present invention is a swirl, or tornado effect, inducing spray nozzle system. FIG. 1 is a perspective cut-away view of a spray nozzle system according to the present invention. FIG. 2 is a bottom view of a spray nozzle system according to the present invention. The spray nozzle system 100 has a spray nozzle 110 through which the substance to be sprayed 170 passes. The spray nozzle system 100 also has a nozzle cone 120. The spray nozzle 110 can be constructed from any suitable materials. The substance being sprayed 170 can be supplied using conventional tubing, fittings, plumbing and the like known in the art. The nozzle cone 120 can be constructed from any suitable materials. In various preferred embodiments, the nozzle cone 120 is constructed from polypropylene.

The nozzle cone 120 can be attached to the spray nozzle 110 through the use of set screws 190 or other means known in the art. An adaptor collar 105 can be used to fit the nozzle cone 120 to the spray nozzle. The nozzle cone 120 has a top opening 160 for receiving or operatively connecting to the spray nozzle 110. The nozzle cone 120 also has a bottom opening 150 that serves as the exit for the substance being sprayed 170. The nozzle cone 120 has a substantially conical interior surface 140.

Disposed on the interior surface 140 of the nozzle cone is a plurality of gas injector ports 130. These gas injector ports 130 are arranged and operated such the gas from the gas injector ports 130 cause the substance being sprayed 170 to rotate inside the nozzle cone 120. In other words, the gas from the gas injector ports 130 imparts a rotational force onto the substance being sprayed 170. In various preferred embodiments, the gas injector ports 130 direct the gas tangentially to interior surface 140. In other various embodiments, the gas injector ports inject the gas perpendicularly to interior surface 140. The gas injector ports 130 may be used at any suitable angle or orientation to the interior surface.

In various preferred embodiments, there are three such gas injector ports 130, located at 120 degree intervals about the interior surface 140. In other various preferred embodiments, the gas injector ports 130 are each located at different distances from the spray nozzle 110. These intervals and distances and intervals are used to start inducing swirl into the substance being sprayed close to the spray nozzle 110 and strengthening and reinforcing the swirl at the substance being sprayed 170 travels through the nozzle cone 120.

Preferably, the gas supply 180 used for the gas injector ports 130 is pressure controlled. In various preferred embodiments, the gas supply 180 pressure for each gas injector port 130 can be individually controlled. Such as discussed above, swirl can start to be induced near the spray nozzle 110 with a relatively low pressure gas, such as 5 psi air, and reinforced with progressively higher pressure gas, such as 15 and 25 psi air. The gas supply 180 can use tubing, fittings, and plumbing known in the art.

Additionally, the gas supply 180 for the gas injector ports can be temperature controlled as well. In various preferred embodiments, the gas supply 180 temperature for each gas injector port 130 can be individually controlled. Temperature control of the gas supply 180 can help maintain the viscosity of the substance being sprayed 170. In other various preferred embodiments, the substance being sprayed 170 is also temperature controlled.

It has been shown that the swirl inducing nozzle system 100 discussed above can used to microencapsulate a lubricant within silicone beads. For example, a first lubricant contains, among other things, silicone. A second lubricant contains, among other things, an emollient. When the first and second lubricants are applied simultaneously using the spray nozzle system 100 discussed above, the emollient of the second lubricant becomes microencapsulated within the silicone beads of the first lubricant. The results of this microencapsulating process means that the emollient of the second lubricant is not exposed while product, such as a bed pad or brief is stored. The weight of a patient being placed on the bed pad or brief releases the emollient of the second lubricant from the silicone beads of the first lubricant.

While specific embodiments have been illustrated and described, numerous modifications come to mind without significantly departing from the spirit of the invention and the scope of protection is limited by the scope of the accompanying claims.

What is claimed is:

1. A swirl inducing nozzle system comprising:
a spray nozzle,
a nozzle cone, said cone having
a substantially conical interior surface defined by a top opening for operatively connecting to said spray nozzle, and a bottom opening,
a plurality of gas injector ports disposed on said interior surface, means for supplying said spray nozzle with a substance to be sprayed, means for supplying said gas injector ports with pressure controlled gas.

2. The swirl inducing nozzle system according to claim 1, wherein said plurality of gas injector ports comprises three gas injector ports disposed on said interior surface.

3. The swirl inducing nozzle system according to claim 2, wherein said three gas injector ports disposed on said interior surface are disposed at one hundred twenty degree intervals about said interior surface.

4. The swirl inducing nozzle system according to claim 1, wherein each of said plurality of gas injector ports is disposed at a different distance from said spray nozzle.

5. The swirl inducing nozzle system according to claim 1, said plurality of gas injector ports direct said pressure controlled gas tangentially to said interior surface.

6. The swirl inducing nozzle system according to claim 1, said plurality of gas injector ports direct said pressure controlled gas perpendicular to said interior surface.

7. The swirl inducing nozzle system according to claim 1, wherein said means for supplying said gas injector ports with pressure controlled gas further comprises means for individually controlling the pressure of said pressure controlled gas for each of said gas injector ports.

8. The swirl inducing nozzle system according to claim 1 further comprising means for controlling the temperature of said pressure controlled gas.

9. The swirl inducing nozzle system according to claim 8, wherein said means for controlling the temperature of said pressure controlled gas comprises means for individually controlling the temperature of said pressure controlled gas for each of said gas injector ports.

10. The swirl inducing nozzle system according to claim 1 further comprising means for controlling the temperature of said substance to be sprayed.

11. A method of inducing swirl into a substance being sprayed comprising:
providing a spray nozzle system having
a spray nozzle,
a nozzle cone, wherein said cone has a substantially conical interior surface defined by a top opening for operatively connecting to said spray nozzle, and a bottom opening, and a plurality of gas injector ports disposed on said interior surface,
supplying said spray nozzle with a substance being sprayed, and
supplying said gas injector ports with a pressure controlled gas.

12. The method of inducing swirl into a substance being sprayed according to claim 11, wherein said plurality of gas injector ports comprises three gas injector ports disposed on said interior surface.

13. The method of inducing swirl into a substance being sprayed according to claim 12, wherein said three gas injector ports disposed on said interior surface are disposed at one hundred twenty degree intervals about said interior surface.

14. The method of inducing swirl into a substance being sprayed according to claim 11, wherein each of said plurality of gas injector ports is disposed at a different distance from said spray nozzle.

15. The method of inducing swirl into a substance being sprayed according to claim 11, said plurality of gas injector ports direct said pressure controlled gas tangentially to said interior surface.

16. The method of inducing swirl into a substance being sprayed according to claim 11, said plurality of gas injector ports direct said pressure controlled gas perpendicular to said interior surface.

17. The method of inducing swirl into a substance being sprayed according to claim 11, wherein said means for supplying said gas injector ports with pressure controlled gas further comprises means for individually controlling the pressure of said pressure controlled gas for each of said gas injector ports.

18. The method of inducing swirl into a substance being sprayed according to claim 11, further comprising controlling the temperature of said pressure controlled gas.

19. The method of inducing swirl into a substance being sprayed according to claim 18, wherein controlling the temperature of said pressure controlled gas comprises controlling, individually, the temperature of said pressure controlled gas for each of said gas injector ports.

20. The method of inducing swirl into a substance being sprayed according to claim 11, further comprising controlling the temperature of said substance to be sprayed.
